(19) United States
(12) Patent Application Publication
(10) Pub. No.: US 2025/0259233 A1
(43) Pub. Date: Aug. 14, 2025

(54) EARNED COMPENSATION ACCESS SYSTEM WITH INTERNAL AND EXTERNAL FUNDING OPTIONS FOR COMPENSATION PAYMENT BEFORE PAYDAY

(71) Applicant: Sultan Abdulaziz Alturki, Riyadh (SA)

(72) Inventor: Sultan Abdulaziz Alturki, Riyadh (SA)

(21) Appl. No.: 18/888,339

(22) Filed: Sep. 18, 2024

(30) Foreign Application Priority Data
Feb. 13, 2024 (SA) SA 1020240628

(51) Int. Cl. G06Q 40/02; G06Q 20/42

(52) U.S. Cl. CPC G06Q 40/02; G06Q 20/42

(57) ABSTRACT

The invention relates to an Earned Compensation Access system that allows employees to access a portion of their earned compensation, such as wages, allowances, bonuses, commissions, and stock options, before payday without borrowing. The system offers two funding options: internal funding from the employer or related entities and external funding from approved banks, financial institutions, or other entities. The process is fully automated, from the employee's request submission to eligibility checks, funding source approvals, and fund transfers. The system manages fees, supports periodic subscriptions, and allows potential revenue sharing. In cases of internal funding, fees can be shared between the Earned Compensation Access entity, employer, or employee. This invention provides a flexible, sustainable funding structure, ensuring seamless, compliant transactions that reduce financial stress for employees and can be offered by third-party entities, financial institutions, or employers.

### CROSS-REFERENCE TO RELATED APPLICATIONS

The present utility application claims the priority of the Saudian patent application number SA 1020240628 filed on Feb. 13, 2024.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to financial technology and human resource management systems, specifically to an automated Earned Compensation Access platform that facilitates the early disbursement of earned compensation to employees before payday. Earned compensation includes wages, allowances, performance bonuses, commissions, and stock options. This system provides a technical solution by fully automating the entire process of compensation access requests, eligibility checks, funding source approvals, and fund transfers, thereby eliminating manual interventions and paperwork traditionally associated with such processes. The system is designed to improve financial flexibility for employees without traditional lending methods, offering partial compensation payments through both internal employer funding or related entities and external financial entities. The invention ensures a fully automated, seamless, and compliant approach, providing secure integration with employer compensation systems and external funding sources. The Earned Compensation Access system can be provided by various entities, such as third-party service providers, financial institutions like banks, related entities, or even directly by the employer, thereby offering flexibility in its deployment and operation.

### Description of the Related Art

Earned Compensation Access (ECA) systems have become increasingly popular as a means to help employees manage their financial needs by allowing them to access a portion of their compensation before payday. Earned compensation includes wages, allowances, performance bonuses, commissions, and stock options. However, existing ECA systems often operate like loan services, where employees essentially borrow against their future earnings, leading to financial dependency and additional costs. Furthermore, these systems typically offer limited flexibility in funding options, often relying solely on either internal compensation management or external lending models, both of which are manually intensive and prone to errors.

Traditionally, the process of receiving part of one's compensation before payday has been manual and cumbersome. Employees would need to submit a request on paper or through direct communication to a manager or compensation officer, who would then manually verify eligibility, approve the request, and process the payment. This manual approach is inefficient, lacks transparency, and often involves delays and human errors. Existing automated systems still do not fully address the needs of modern workplaces, either due to their reliance on outdated models like loans or their limited integration with multiple funding sources.

Several patents in the field attempt to address the challenges associated with early compensation access and management:

U.S. Pat. No. 10,007,953B1-Describes a compensation service provider system that integrates employer compensation information and transaction data to manage compensation payments. While this system allows for some degree of compensation management, it is fundamentally based on predictive models and historical data analysis to adjust payments, which can be complex, restrictive, and not fully automated. The present invention overcomes this by offering a fully automated, direct approach to funding, focusing on employee choice and flexibility rather than predictive adjustments.

U.S. Pat. No. 11,538,118B2-Focuses on providing cash advances to merchants through a payment processing service based on transaction data and risk assessments. This system is limited to merchant cash advances and does not provide a direct employee-centric or fully automated solution for accessing earned compensation. The present invention innovates by eliminating the cash advance model altogether, instead providing a direct compensation payment method that is not dependent on risk assessments or complex data models, and automating the entire process from request to payment.

U.S. Pat. No. 11,636,484B2-Details a method for providing cash access to earned income using a network of cash access points, like ATMs or kiosks, with a focus on security protocols. Although it facilitates early access to compensation, it requires physical infrastructure and focuses on cash disbursement, which can be inconvenient, less flexible, and only partially automated. The present invention improves upon this by integrating with digital banking systems, providing a purely digital, fully automated interface that avoids the need for physical cash handling and focuses on direct bank transfers.

The invention, EARNED COMPENSATION ACCESS SYSTEM WITH INTERNAL AND EXTERNAL FUNDING OPTIONS FOR PARTIAL COMPENSATION PAYMENT BEFORE PAYDAY, addresses the limitations of existing systems by providing a fully automated, non-loan-based ECA solution. Unlike prior art, this invention offers a dual funding approach that includes internal funding directly from the employer or related entities and external funding from various financial providers or related entities, all managed within an automated system. This flexibility allows employees to access their compensation without incurring debt, maintains transparency in transaction management, and integrates seamlessly into employer compensation processes. The invention eliminates the need for predictive financial models, complex risk assessments, or manual processing seen in prior systems, providing a straightforward, automated, and efficient mechanism for early compensation payments. In cases of external funding, the liability remains with the funding entity, not the employee.

The invention, EARNED COMPENSATION ACCESS SYSTEM WITH INTERNAL AND EXTERNAL FUNDING OPTIONS FOR PARTIAL COMPENSATION PAYMENT BEFORE PAYDAY, introduces several innovative features that distinguish it from existing systems:

Dual Funding Options: The invention offers both internal and external funding options, allowing employers or related entities to fund early compensation access directly from their budget or enabling employees to choose from multiple approved external financial providers. This flexibility is not available in existing patents, which tend to focus on either internal compensation adjustments or third-party lending models, not both.

Employee-Centric Marketplace: Unlike prior art that is often centered around employer or merchant needs, this system introduces an employee-centric marketplace where employees can compare different external or internal funding offers based on their preferences. This feature empowers employees to make informed choices regarding their early compensation access, enhancing their financial independence.

Non-Lending, Direct Compensation Payment: The system innovates by providing a direct compensation payment model rather than a loan or cash advance. Employees access their earned compensation, not borrowed money, eliminating the debt cycle often associated with traditional cash advance systems. This is a critical innovation, reducing financial stress and dependency among employees. Comprehensive Dashboard Integration: The invention features four integrated dashboards tailored for each stakeholder: the employee, employer, external fund provider, and the ECA entity. This clear division and integration of roles ensure that all parties have real-time visibility and control over the compensation access process, improving transparency and operational efficiency.

Enhanced Compliance and Security: The system is designed with compliance and security in mind, utilizing robust data encryption, multi-factor authentication, and secure API integrations. This ensures the system aligns with regulatory standards like the General Data Protection Regulation (GDPR), the California Consumer Privacy Act (CCPA), and the Payment Card Industry Data Security Standard (PCI-DSS), providing a secure and compliant solution that is not explicitly addressed in existing patents.

Fully Automated Process from Start to Finish: The invention automates the entire process, from the employee's request submission through eligibility checks, funding approvals, and final disbursement, reducing manual intervention and errors while increasing efficiency.

Fee Transparency and Management: The platform provides a transparent fee structure for both service fees and transaction fees, which can be charged to the employee, employer, or shared between both parties. This transparency contrasts with traditional systems, where hidden fees or unclear terms can add to the financial burden on employees.

The present invention overcomes the limitations of existing ECA systems by providing a flexible, secure, fully automated, and employee-centric solution for early compensation access. By combining dual funding options, a non-lending model, comprehensive dashboards, and a focus on compliance and automation, the invention offers a novel approach that significantly improves upon the prior art in this field.

### SUMMARY OF THE INVENTION

The present invention provides a fully automated Earned Compensation Access system that enables employees to access a portion of their earned compensation before payday without the need for traditional lending. The compensation covered by the system includes wages, allowances, performance bonuses, commissions, and stock options. The system offers dual funding options:

Internal Funding: Employers or related entities allocate a specific budget for early payments. The system deducts the accessed amount from the employee's compensation on payday and returns it to the employer's budget. In this model, fees may apply, and these can be shared between the Earned Compensation Access entity and the employer, or between the Earned Compensation Access entity and the employee, depending on the agreed arrangement.

External Funding: Employees or entities can select from approved banks, financial institutions, or other relevant entities through an automated marketplace integrated into the system. This allows for flexibility and choice, letting employees compare different offers based on fees, terms, and conditions. The system facilitates the entire selection and approval process, ensuring efficient and secure fund transfers to the employee's bank account.

The invention's automation capabilities cover the entire process—from an employee's request submission, eligibility checks, funding source approvals, and final fund transfers—without requiring manual intervention. The system's robust architecture supports a transparent fee management structure, real-time financial settlements among stakeholders, and options for periodic subscriptions and potential revenue-sharing agreements.

The invention is designed to integrate securely with employers' compensation systems and external funding providers. It ensures compliance with financial regulations such as GDPR, CCPA, and PCI-DSS, maintaining data security through encryption, multi-factor authentication, and secure API integrations. This system can be provided by third-party service providers, financial institutions, or directly by employers, offering flexibility in its deployment.

By combining automated processes, dual funding options, comprehensive dashboards for stakeholders, and a focus on compliance and security, the invention provides a novel, employee-centric solution that reduces financial stress, enhances financial flexibility, and supports sustainable, flexible funding structures.

### DESCRIPTION OF THE DRAWINGS

The accompanying drawings illustrate the components, workflows, and fully automated processes of the Earned Compensation Access (ECA) system in accordance with the present invention:

FIG. 1—General System Overview.

FIG. 2—Employee Workflow.

FIG. 3—Employer Workflow.

FIG. 4—Financial Provider Workflow.

### DETAILED DESCRIPTION OF THE INVENTION

The present invention relates to an automated Earned Compensation Access (ECA) system that allows employees to access a portion of their earned compensation, equivalent to the days they have worked before payday, without lending money. The system operates through a comprehensive digital platform with four distinct dashboards for different stakeholders: the ECA entity, the employer, the external funding providers or related entities, and the employee. This automated system improves financial flexibility for employees, provides financial benefits for employers, and offers a structured marketplace for external fund providers or related entities.

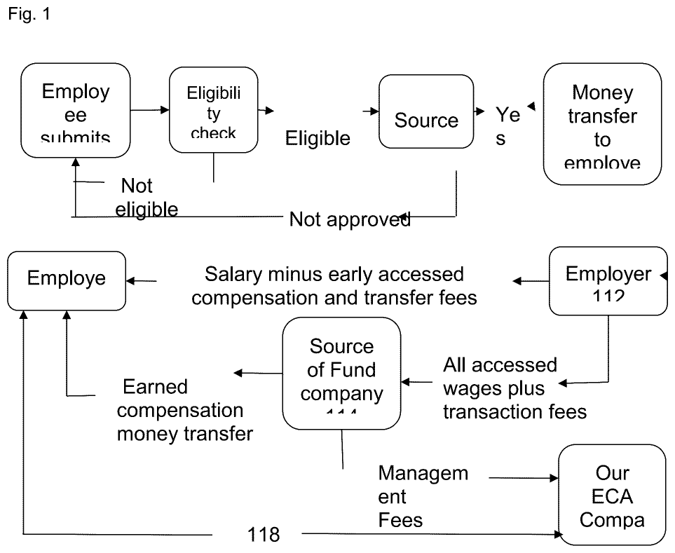

### FIG. 1—General System Overview (100):

FIG. 1 provides a high-level overview of the ECA system, showing the entire automated workflow from the initial request to the final settlement. The key components and their detailed functions are described below:

### Employee Submits a Request (102):

The employee logs into the system using their credentials and submits a request to access part of their earned compensation. The system is designed to automatically calculate the available amount based on the number of days worked and the employee's compensation rate, ensuring they only access what they have already earned. This step involves the system's backend calculating the pro-rata compensation for the days worked without manual intervention.

### Eligibility Check (104):

The system performs an automated eligibility check based on predefined criteria set by the employer or other related entities, such as employment status, performance metrics, attendance records, and other relevant factors. The system uses a secure algorithm to evaluate these parameters and determine eligibility in real-time. If the employee does not meet the criteria, the system sends an automated rejection notice with the reasons for ineligibility.

### Source of Fund Approval (106):

If the employee is eligible, the system moves to the source of fund approval stage. This involves two possible automated options:

### Internal Funding by Employer (112):

The employer may choose to offer internal funding. In this scenario, the employer's dashboard is configured to manage a specific budget for early compensation payments. The system automatically deducts the accessed amount from the employee's compensation on payday and returns it to the employer's budget. Fees may apply in case of internal funding, and these fees can be shared between the ECA entity and the employer, or between the ECA entity and the employee, or among any agreed-upon parties, depending on the arrangement. This option provides a cost-effective solution with better control over cash flow for employers.

External Funding from Providers (114): If internal funding is not offered, the employee or related entity is directed to a marketplace where they can select from a range of external financial providers. The employee or related entity can compare offers based on fees, terms, and other criteria. Once selected, the system interfaces with the provider's dashboard to facilitate the transfer and manage the agreement, automating the entire selection and approval process.

### Money Transfer to Employee Bank Account (108):

Upon approval, whether internal or external, the requested amount is automatically transferred directly to the employee's bank account. The transfer process is secured using industry-standard encryption protocols and real-time processing through banking integrations to ensure speed and reliability, eliminating the need for manual handling.

### Fee Management and Financial Settlement:

The system includes a robust, automated fee management module that calculates fees associated with accessing early compensation and using the ECA platform. These fees are charged to the employee or related entities and are transparently displayed at each step of the process. Additionally, the system handles the automated settlement between employers, external fund providers, and the ECA entity, ensuring all parties receive the correct amounts and service fees, including potential revenue sharing from periodic subscriptions.

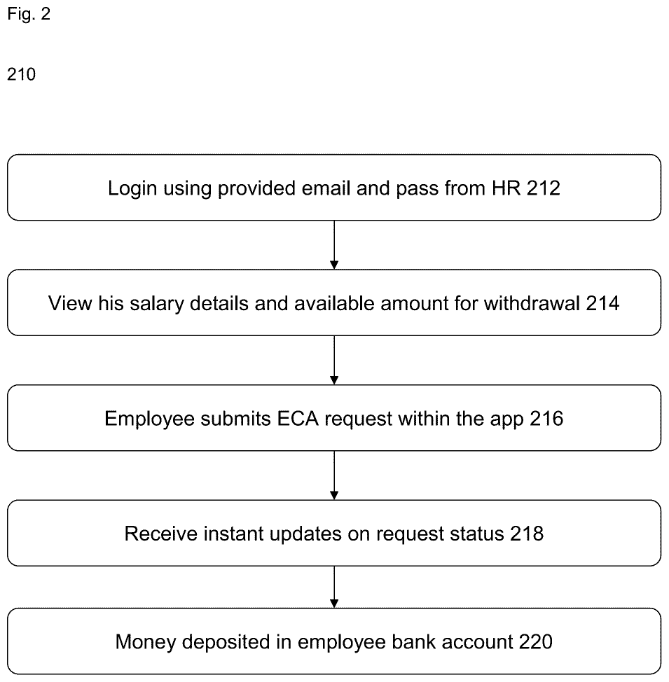

### FIG. 2—Employee Workflow (210);

FIG. 2 outlines the automated workflow from the employee's perspective, detailing the steps involved in accessing early compensation:

Login Using Provided Email and Password from HR (212):

Employees receive credentials from their HR department and use them to log into the ECA platform. The system uses multi-factor authentication (MFA) to ensure secure access, automating the security process.

### View Compensation Details and Available Amount for Withdrawal (214):

After logging in, employees can view detailed information about their compensation, including the total earned amount and the portion available for early withdrawal. The interface is designed to be user-friendly, displaying a clear breakdown of the compensation calculations, all managed automatically by the system.

### Employee Submits ECA Request Within the App (216):

Employees submit a request for early compensation access through a simple, intuitive interface. The app provides options for selecting internal or external funding, based on the availability set by the employer or other related entities, automating the decision-making process.

### Receive Instant Updates on Request Status (218):

The system provides real-time automated updates on the status of the request, including eligibility, funding approval, and transfer status. Notifications are sent via the app and email to keep the employee informed at each stage.

### Money Deposited in Employee Bank Account (220):

Once approved, the requested compensation amount is securely deposited into the employee's bank account. The system logs all transactions and provides a detailed receipt for the employee's records, automating the entire payment and documentation process.

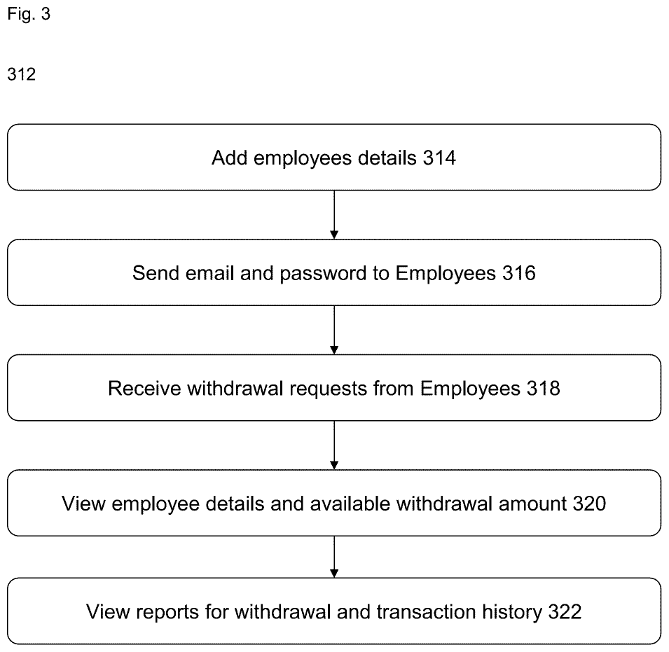

### FIG. 3—Employer Workflow (312):

FIG. 3 describes the automated workflow from the employer's perspective, focusing on how they manage employee requests and the internal funding option:

### Add Employee Details (314):

The employer uses the dashboard to add employee details, such as name, role, compensation, and eligibility criteria. This information is securely stored in the system's database and is used to process ECA requests, all automated by the system.

### Send Email and Password to Employees (316):

The employer generates unique login credentials for each employee and sends them via email. This step includes automated emails that guide employees on how to access the system, ensuring seamless onboarding.

Receive Withdrawal Requests from Employees (318):

The employer's dashboard allows them to view and manage withdrawal requests from employees. The employer can approve or deny requests based on their internal policies and funding availability, all managed through automated workflows.

### View Employee Details and Available Withdrawal Amount (320):

The employer can access detailed information on each employee, including the amount available for withdrawal and any previous requests. This helps in decision-making and budget management, with automated data processing.

### View Reports for Withdrawal and Transaction History (322):

The system provides comprehensive automated reporting tools that allow employers to view historical data on withdrawals, fees, and overall usage. These reports can be exported for further analysis and auditing.

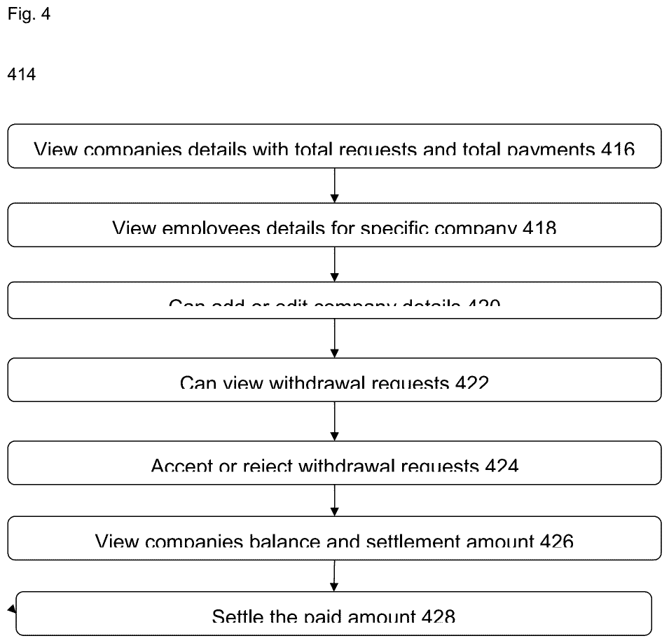

### FIG. 4—Financial Provider Workflow (414):

FIG. 4 illustrates the automated workflow for external financial providers or related entities participating in the external funding marketplace:

View Company Details with Total Requests and Total Payments (416):

The financial provider dashboard provides an overview of all registered companies, total requests received, and total payments made, enabling them to track demand and manage their offerings effectively, all through automated data management.

### View Employee Details for Specific Company (418):

The financial provider can view details of employees or related entities requesting external funding, including the amount requested, repayment terms, and eligibility, all managed automatically by the system.

### Add or Edit Company Details (420):

The financial provider can add or modify details about the companies they service, ensuring accurate data management through automated processes.

### View Withdrawal Requests (422):

The dashboard allows the financial provider to view all withdrawal requests in real-time, enabling them to respond promptly through automated decision-making tools.

### Accept or Reject Withdrawal Requests (424):

Based on predefined criteria, the financial provider can accept or reject withdrawal requests. Rejection reasons are communicated to the employee through the automated system.

### View Company Balance and Settlement Amount (426):

The financial provider can monitor balances and settlement amounts for each company they are partnered with, helping them manage cash flow and ensure timely settlements, all managed by the system's automated financial reconciliation tools.

### Settle the Paid Amount (428):

The financial provider handles the settlement process, ensuring that all accessed compensation amounts and associated fees are reconciled accurately and promptly through automated mechanisms.

### Alternative Embodiments and Edge Cases

The system can accommodate various scenarios, such as handling errors in bank transfers, managing incomplete employee information, and adapting to different employer policies. For example, if an employer decides to change their internal funding policy, the system can dynamically update options available to employees without requiring significant reconfiguration.

### Security and Compliance:

The system is designed with robust security features, including data encryption, multi-factor authentication (MFA), secure API integrations, and regular audits to comply with financial regulations like GDPR (General Data Protection Regulation), CCPA (California Consumer Privacy Act), and PCI-DSS (Payment Card Industry Data Security Standard). These measures ensure the confidentiality, integrity, and availability of sensitive data, all managed through automated security protocols.

### User Interface and Experience:

The system provides a seamless user experience across all dashboards, with intuitive navigation, real-time notifications, and clear call-to-action buttons. The interfaces are designed to minimize training requirements and maximize efficiency for all users, leveraging automation to streamline all interactions.

### CONCLUSION

The invention provides a comprehensive, fully automated Earned Compensation Access (ECA) system that offers employees flexibility and financial empowerment by allowing them to access a portion of their compensation equivalent to the days worked before payday. With detailed workflows, robust security, and multiple funding options, the invention delivers a secure, scalable, and user-friendly solution that benefits employees, employers, and financial providers or related entities alike.

In another embodiment, the earned compensation system can be expanded to provide compensation for future periods that may not have been earned at the time the request is made by the employee. This facilitates access to funds in a way that is low-risk and cost-effective.

1. A system for providing early access to earned compensation for employees, comprising:
a first dashboard designed for use by the entity responsible for the Earned Compensation Access (ECA) system, comprising:
a user interface for managing system operations, including monitoring earned compensation access requests, managing transaction fees, and overseeing automated financial settlements;
a module for integration with internal or external funding sources and employer compensation systems to facilitate data exchange and automated processing;
a fee management component that automatically calculates fees for the services provided, displays them to the relevant parties, and transfers fees to the related parties based on agreed terms;
a second dashboard designed for use by the employer, comprising:
a module for entering and managing employee details, including employment status, compensation information, and eligibility criteria for early earned compensation access;
a component for receiving and processing earned compensation access requests from employees, where requests are approved or denied based on internal policies, all managed automatically;
a reporting tool that generates automated reports on withdrawal requests, transaction history, and usage analytics;
an internal funding management module that allocates a specific budget for early earned compensation payments and adjusts the remaining budget in real-time based on withdrawal requests;
a third dashboard designed for use by external funding sources or related entities, comprising:
an automated module for approving or rejecting earned compensation access requests based on predefined criteria set by the funding provider;
an automated financial settlement system for reconciling the accessed compensation and associated fees with the employer and the entity responsible for the ECA system;
an automated tool for managing company details and monitoring financial activities, including total requests and payments, without manual oversight;
a fourth dashboard designed for use by the employee, allowing the employee to view their earned compensation and submit a request to access it;
a communication network connecting the first, second, third, and fourth dashboards to enable secure, real-time data exchange, transaction processing, and status updates;
a central processing system that manages earned compensation access requests, eligibility checks, funding source approvals, fee calculations, and payment settlements automatically, wherein the central processing system is programmed to:
receive a request for earned compensation access from an employee;
perform an automated eligibility check based on criteria set by the employer or related entities;
determine the funding provider, whether internal from the employer or related entities, or external from a funding source;
automatically allocate internal funds for approved requests from the employer's budget and update the remaining budget in real-time;
initiate an automated transfer of the approved amount to the employee's bank account.

2. The system according to claim 1, wherein the first dashboard further comprises:
an electronic marketplace module that allows employees or related entities to compare offers from internal and external funding sources based on fees and terms, managed automatically by the system;
a notification module that provides real-time, automated updates to employees regarding the status of their earned compensation access requests.

3. The system according to claim 1, wherein the central processing system is programmed to:
handle errors and automated notifications in case of a rejected earned compensation access request, including communicating the reasons for rejection to the employee and providing alternative options if available;
ensure compliance with financial regulations, including data encryption, multi-factor authentication, and secure API integrations.

4. The system according to claim 1, wherein the communication network is programmed to:
support real-time communication and data exchange between the first, second, third, and fourth dashboards automatically;
ensure the secure transmission of sensitive information, including personal data, financial information, and transaction details, without manual handling.

5. The system according to claim 1, wherein the central processing system is programmed to generate and store:
automated compliance reports that track all earned compensation access transactions, approvals, and rejections for auditing purposes;
usage analytics that provide insights into employee behavior, employer funding preferences, and activities of external service providers, managed automatically.

6. A method for providing early access to earned compensation for employees using an automated Earned Compensation Access (ECA) system, comprising:
receiving, by a central processing system, a request from an employee to access a portion of earned compensation before payday through an automated system interface;
performing, by the central processing system, an automated eligibility check based on predefined criteria set by the employer or any other agreed party, including employment status, performance metrics, and attendance records, without manual intervention;
determining, by the central processing system, the funding provider for the earned compensation access request through an automated decision-making process, where the funding provider is either internal funding from the employer's designated budget or any related legal entity, or external funding from a funding source;
automatically evaluating the capacity for internal funding and directing the request accordingly if internal funding is available;
transmitting, by the central processing system, the earned compensation access request to the specified internal or external funding provider for automated approval or rejection based on predefined criteria set by the internal or external funding provider;
receiving, by the central processing system, an automated approval or rejection response from the funding provider, and in the case of rejection, sending an automated notification to the employee with the reasons for rejection;
initiating, by the central processing system, an automated transfer of the approved amount to the employee's bank account if the request is approved, using secure, real-time processing through banking system integrations;
calculating, by an automated fee management component, the fees associated with earned compensation access and transaction fees, and automatically transferring them to the relevant bank accounts for the agreed parties, with the system automatically choosing from among these offers as displayed in the system interface before finalizing the transaction;
updating the status of the earned compensation access request in real-time on the dashboards of the employee, employer, and funding provider;
performing an automated financial settlement for the transferred amounts and associated fees between the employer, external funding provider, the entity responsible for the ECA system, or any other related legal entities, ensuring accurate settlement without manual intervention.

7. The method according to claim 6, further comprising:
providing, through the employee dashboard, a user interface that allows employees to log in, view available withdrawal amounts based on accrued periods worked, and submit earned compensation access requests, all managed by the automated system;
facilitating, through the employer dashboard, the management of employee eligibility criteria, reviewing withdrawal requests, and approving or denying requests based on company policy, using automated workflows;
enabling, through the internal or external funding source dashboard, viewing of registered companies, managing earned compensation access requests, and handling financial settlements through automated systems.

8. The method according to claim 6, wherein the central processing system also:
detects errors in transaction processing and triggers an automated resolution protocol, which includes notifying all relevant parties and providing alternative funding options if available;
ensures security and compliance with regulatory standards, such as the General Data Protection Regulation (GDPR), the California Consumer Privacy Act (CCPA), and the Payment Card Industry Data Security Standard (PCI-DSS), through continuous monitoring and automated updates to security protocols.

9. The method according to claim 6, wherein the step of determining the funding provider further comprises:
presenting, through the employee dashboard, a list of available internal and external funding providers and their terms in an automated manner;
allowing the employee to select a preferred internal or external provider based on fees, terms, and available funding options, all managed by the system.
